(19) United States
(12) Patent Application Publication
(10) Pub. No.: US 2007/0026174 A1
(43) Pub. Date: Feb. 1, 2007

(54) Plastic dispensing container having reduced moisture penetration and method for same

(76) Inventors: Cliff Labbe, Somerset, NJ (US); Robert Miskevich, Bangor, PA (US)

Correspondence Address: PAUL D. GREELEY, ESQ.;OHLANDT, GREELEY, RUGGIERO & PERLE, L.L.P., 10th FLOOR, ONE LANDMARK SQUARE, STAMFORD, CT, 06901-2682, US

(21) Appl. No.: 11/541,030

(22) Filed: Sep. 29, 2006

Related U.S. Application Data
(62) Division of application No. 10/918,224, filed on Aug. 13, 2004.

(51) Int. Cl. B32B 27/08

(52) U.S. Cl. 428/35.7

(57) ABSTRACT

A method for reducing the permeation of moisture into a dispensing tube container having a head and a tube sleeve, wherein the head has a shoulder and a neck, and wherein the tube sleeve has two ends and one of those ends is attached to the shoulder; comprising: adding a dessicant to the head in an amount sufficient to reduce the rate of permeation of moisture therethrough.

### CROSS-REFERENCED APPLICATIONS

This application is a divisional application of U.S. patent application Ser. No. 10/918,224, filed on Aug. 13, 2004, and claims priority thereto in its entirety.

### BACKGROUND OF THE INVENTION

1. Field of the Invention

The present invention relates to a plastic dispensing tube container exhibiting reduced moisture penetration or infiltration. The present invention further relates to a method for reducing moisture permeation into a plastic dispensing tube container.

2. Description of the Prior Art

Plastic tube containers are employed commercially to store and dispense a variety of products, including those in the form of creams, ointments, pastes, liquids, semi-solids, lotions and the like. Products include personal care products, consumer products, and industrial products. Dispensing tube containers typically comprise a tube sleeve, a head, and a closure. The head is heat welded or otherwise affixed to or mated with an end of the tube sleeve. The head defines a shoulder and a neck extending from the shoulder with a passageway therethrough. The neck is adapted to receive and engage with a closure. The neck and the closure may engage by known means such as mating threads or snap beads. The end of the tube sleeve opposite the head is sealed after the chamber within the sleeve is filled with product.

Some products are particularly sensitive to pre-mature moisture penetration or infiltration. Pre-mature moisture penetration or infiltration may result in product spoilage or pre-mature curing. Moisture-sensitive products include RTV (room-temperature vulcanized) silicone adhesives and cyanoacrylates.

One means of addressing the problem of storing and dispensing moisture-sensitive products is to employ tube sleeves having one or more barrier layers to reduce the permeation rate of moisture, i.e., water vapor, into the dispensing tube container. The barrier layer(s) are typically comprised of known barrier materials, such as polyolefins, e.g. high density polyethylene and polypropylene, and metal foils. Plastic dispensing containers having tube sleeves with barrier layers are shown in U.S. Pat. Nos. 4,471,268; 4,698,247 and 4,986,053.

Even when employing tube sleeves having barrier layers, prior art dispensing tube containers frequently do not prevent moisture penetration to a sufficient degree. Accordingly, it would be desirable to have a plastic dispensing tube container that provides a lower rate of moisture penetration or infiltration. Further, it would be desirable to have a method for reducing rate of moisture penetration into plastic dispensing tube containers. Still further, it would be desirable to have a method for extending the shelf life of products within plastic dispensing tube containers.

### SUMMARY OF THE INVENTION

According to the present invention, there is a plastic dispensing tube container. The container has a head and a tube sleeve. The head also has a shoulder and a neck. The sleeve has two ends with one end thereof attached to the shoulder. The head also has a dessicant therein in an amount sufficient to reduce the permeation of moisture, i.e., water vapor, through a portion of or the entirety of the head.

Further according to the present invention, there is a method for reducing the permeation of moisture into a dispensing tube container. The container has a head and a tube sleeve. The head has a shoulder and a neck. The tube sleeve has two ends with one end thereof attached to the shoulder. The method has the step of adding a dessicant to the head in an amount sufficient to reduce the permeation of moisture through a portion of or the entirety of the head.

### DESCRIPTION OF THE FIGURES

FIG. 1 is a perspective view of a dispensing tube container in accordance with the present invention.

FIG. 2 is a perspective view of the container of FIG. 1 with a cap screwed on.

FIG. 3 is a cross-section view of the container of FIG. 1 along a line 3-3.

FIG. 4 is a close-up, enlarged, cross-section view of the tube sleeve of the container of FIG. 1 as shown in FIG. 3.

### DETAILED DESCRIPTION OF THE INVENTION

The head of the dispensing tube container of the present invention has a dessicant therein in an amount sufficient to reduce the rate of permeation of moisture through the head relative to the rate without the dessicant. The dessicant is preferably present in the head in an amount about 0.1 to about 25 wt %, more preferably about 0.5 to about 10 wt %, and most preferably 0.5 to about 5 wt % based upon the total weight of the head. The dessicant may be present in a portion of or the entirety of the head. The dessicant may be present in either or both of the shoulder and the neck. Preferably, the dessicant is admixed substantially homogeneously throughout the entirety of the head. Alternately, the dessicant may be present in one or more film layers at the interior or exterior surfaces of the head.

The dessicant may be any substance which reduces the rate of permeation of moisture (water vapor) when dispersed in the head. The dessicant may reduce the rate of permeation by any means, such as by absorption, reaction, and physical absorption. Dessicants that function via absorption include anhydrous salts that absorb water to form more stable salts. Dessicants that function via reaction (e.g., hydrolysis) react with water to form new compounds. Dessicants that function via physical absorption water physically entrain water via capillary action. Examples of dessicants which operate primarily via absorption include, but are not limited to, ammonium chloride, calcium chloride, calcium carbonate, calcium oxide, potassium chloride, potassium carbonate, sodium chloride, sodium phosphate di-basic, sodium pyrophosphate, and sodium nitrate. Examples of dessicants which operate primarily through physical absorption include, but are not limited to, molecular sieves, silica gels, clays, and starches. Additional teachings regarding dessicants are shown at columns 6 and 7 of U.S. Pat. No. 6,080,350, the columns of which are incorporated herein by reference.

Dispensing tubes may be produced by any method known in the art such as extrusion or lamination. In extrusion, a plastic tube sleeve is extruded continuously then cut into discrete lengths that form the body wall of the tube. A tube head is then heat welded or adhered to one end of a tube sleeve, the top of the neck snipped or removed to open it (if necessary), and a closure in the nature of a cap, top, or lid applied to the neck. The other open end of the tube sleeve is typically filled with product to be dispensed and then sealed by heat, adhesive, or mechanical means. In lamination, a sheet of plastic material or composite such as plastic/metal foil is rolled to a tubular shape and sealed along the sheet edges to form a continuous tube sleeve. The tube sleeve is cut into discrete lengths, head and closure applied, filled with product at the open end, and the end sealed in the same manner as an extruded tube. Laminates may have both extruded and non-extruded layers. Useful extrusion techniques include, but are not limited to, cast extrusion and blown extrusion.

The dessicant may be admixed or blended into the plastic material making up the head by any means known in the art. The dessicant may be introduced into a melt of the plastic material in a mixer or extruder. The dessicant may also be dry-blended with granules or powders of the plastic material and fed to an extruder or mixer. The dessicant may also be pre-compounded in a plastic material and granules or powders of the material subsequently fed along with additional plastic to an extruder or mixer.

If desired for additional protection against moisture vapor infiltration, a dessicant may be incorporated into the sleeve of the tube container. The dessicant can be dispersed substantially throughout the sleeve or any part thereof. Alternately, the dessicant may also be incorporated into the sleeve in the form of an extruded or laminated sublayer or film layer.

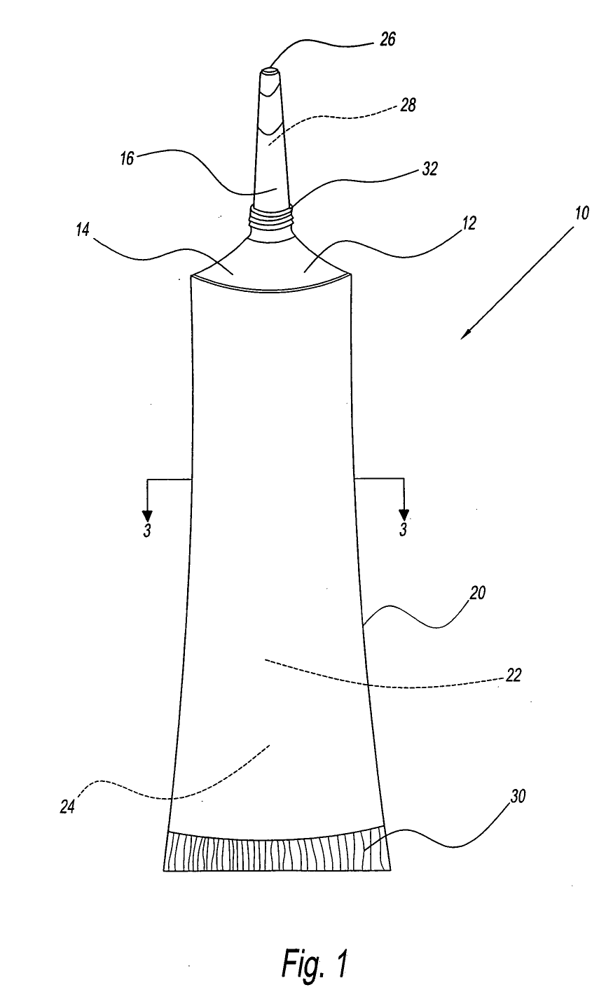

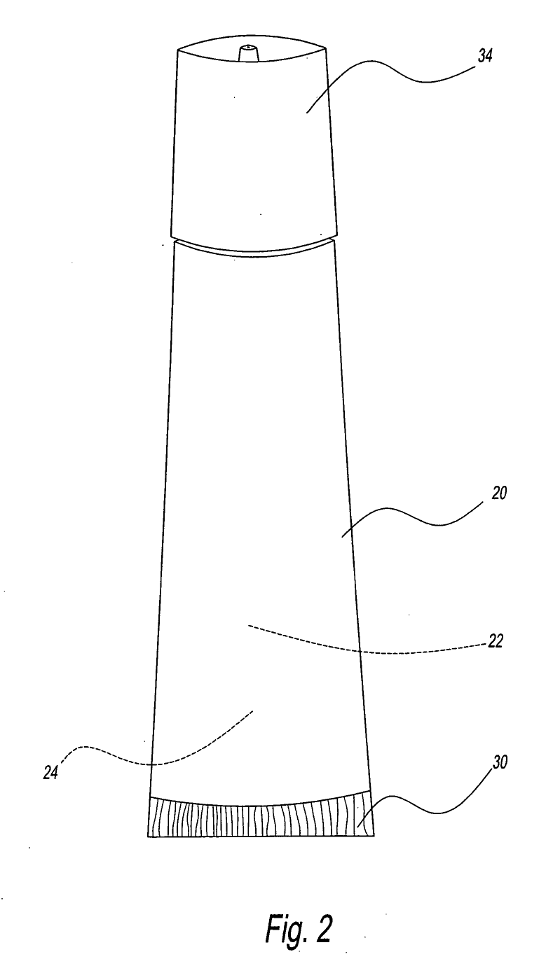

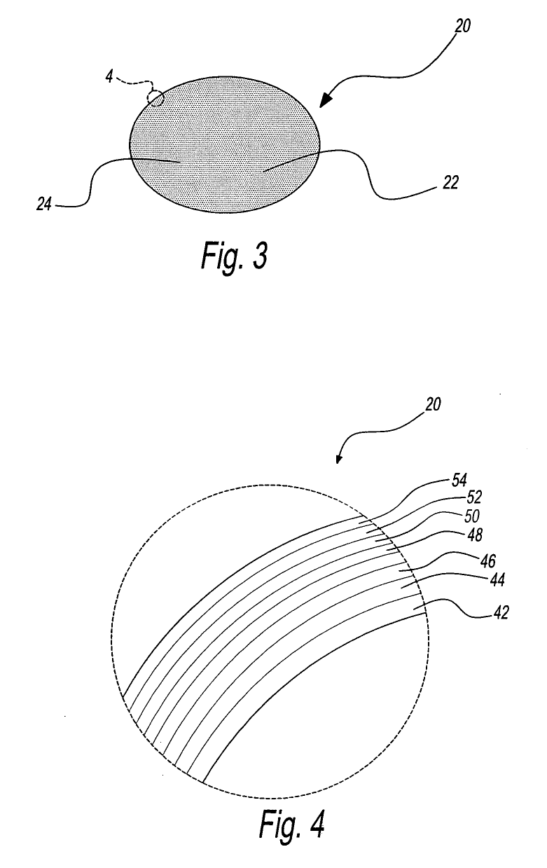

A dispensing tube container is shown in FIGS. 1 to 4, and is generally referenced by the numeral 10. Container 10 has a head 12 heat welded to one end of a tube sleeve 20. Head 12 has a shoulder 14 and a neck 16. As also seen in FIG. 3, sleeve 20 defines a chamber 22 therein for retaining a dispensable product 24. Neck 16 has an orifice 26 therein and a passageway 28 therethrough in communication with chamber 22 so that product 24 is conveyed through orifice 26 and passageway 28 upon squeezing or mechanical manipulation of sleeve 20. The end of sleeve 20 opposite head 12 terminates at seal 30, which takes the form of a heat seal at an end portion of sleeve 20. Neck 16 has threads 32 adapted to receive screw cap 34 (the closure).

The closure and head may be manufactured according to any method known in the art such as injection molding or stamping with a plastic material. Injection molding is preferred.

The tube dispenser, including the tube sleeve, head, and closure, may be manufactured from any plastic material known in the art. Representative plastic materials include, but are not limited to, ethylene polymers, propylene polymers, polyesters, and polyamides. Useful ethylene polymers include low density polyethylene, medium density polyethylene, high density polyethylene and linear low density polyethylene. A useful propylene polymer is polypropylene. Useful polyesters include polyethylene terephthalate. Preferred plastic materials for the head and the closure are high density polyethylene and polypropylene. A preferred plastic material for an extruded tube sleeve is low density polyethylene, or, in the case of a barrier sleeve, high density polyethylene. Preferred plastic materials for laminate tube sleeves include low density polyethylene and linear low density polyethylene. Preferably, the head and closure are of a plastic material more rigid than the tube sleeve. Adhesive or tie layers may be employed as necessary. Plastic materials useful in adhesive layers include, but are not limited to, ethylene/vinyl acetate copolymers, ethylene/acrylic acid copolymers, and ionomers.

Containers of the present invention are particularly useful in dispensing moisture-sensitive products, such as RTV silicone adhesives and cyanoacrylates.

In a preferred embodiment of the dispensing tube container, the tube sleeve is multilayer and has one or more barrier layers. Useful materials for barrier layers include metal foils, an ethylene/vinyl alcohol copolymers, and combinations of the foregoing. An embodiment for a multilayer structure has the following: a) a first layer (inner layer) of a heat sealable, thermoplastic polymer, b) a first adhesive layer, c) a layer of an ethylene/vinyl alcohol copolymer, d) a second adhesive layer, e) a layer of a metal foil, f) a third adhesive layer, and g) a second layer (outer layer) of a thermoplastic polymer. FIG. 4 illustrates this embodiment. Sleeve 20 has an inner layer 42 of a heat sealable, thermoplastic polymer, a first adhesive layer 44, a ethylene/vinyl alcohol copolymer layer 46, a second adhesive layer 48, a metal foil layer 50, a third adhesive layer 52, an outer layer 54 of a thermoplastic material. Layers of ethylene/vinyl alcohol copolymers are useful in preventing delamination of subsequent layers due to attack by aggressive products or contents within the tube container. Otherwise, the layer of ethylene/vinyl alcohol copolymers and their attendant adhesive layers are optional. Another embodiment of a multilayer structure is the following: a) a first layer of a heat sealable, thermoplastic polymer, b) a first adhesive layer, c) a barrier layer, d) a second adhesive layer, and e) a second layer of a thermoplastic polymer, wherein the ordering of the layers is from inside to outside. Plastic dispensing containers having tube sleeves with barrier layers are shown in U.S. Pat. Nos. 4,471,268; 4,698,247 and 4,986,053, which are incorporated herein by reference.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is :

1. A method for reducing the permeation of moisture into a dispensing tube container having a head and a tube sleeve, wherein the head has a shoulder and a neck, and wherein the tube sleeve has two ends and one of those ends is attached to the shoulder; comprising:
adding a dessicant to the head in an amount sufficient to reduce the rate of permeation of moisture therethrough.

2. The method of claim 1, wherein the dessicant is added to the head in an amount about 0.1 to about 25 wt % based upon the total weight of the head.

3. The method of claim 1, wherein the dessicant is added to the head in an amount about 0.5 to about 10 wt % based upon the total weight of the head.

4. The method of claim 1, wherein the dessicant is added to the head in an amount about 0.5 to about 5 wt % based upon the total weight of the head.

5. The method of claim 1, wherein the dessicant is added to both the shoulder and the neck.

6. The method of claim 1, wherein the dessicant is dispersed substantially homogeneously throughout the entirety of the head.

7. The method of claim 1, wherein the tube sleeve has one or more barrier layers of one or more materials selected from the group consisting of a metal foil, high density polyethylene, polypropylene, and combinations of the foregoing.

8. The method of claim 1, wherein the tube sleeve is a laminate having a) a first layer of a heat sealable, thermoplastic polymer, b) a first adhesive layer, c) a layer of an ethylene/vinyl alcohol copolymer, d) a second adhesive layer, e) a layer of a metal foil, f) a third adhesive layer, and g) a second layer of a thermoplastic polymer, wherein the ordering of the layers is from inside to outside.

9. The method of claim 1, wherein the tube sleeve is a laminate having a) a first layer of a heat sealable, thermoplastic polymer, b) a first adhesive layer, c) a barrier layer, d) a second adhesive layer, and e) a second layer of a thermoplastic polymer, wherein the ordering of the layers is from inside to outside.

10. The method of claim 1, wherein the dessicant is selected from the group consisting of ammonium chloride, calcium chloride, calcium carbonate, potassium chloride, potassium carbonate, sodium chloride, sodium phosphate di-basic, sodium pyrophosphate, sodium nitrate, molecular sieves, silica gels, clays, and starches.

11. The method of claim 1, wherein the dispensing tube container has a product within the tube sleeve and a seal at the end of the sleeve opposite the shoulder.

12. The method of claim 11, wherein the dispensing tube container has a closure engaged with the neck.

13. The method of claim 11, wherein the product is an RTV silicone adhesive.
